(19) United States
(12) Patent Application Publication
(10) Pub. No.: US 2008/0107768 A1
(43) Pub. Date: May 8, 2008

(54) Method for increasing the health condition of crustaceans in aquaculture

(75) Inventors: Eduardo Aguirre Hinojosa, Monterrey (MX); Ma. del Carmen Garza Aguirre, Monterrey (MX); Ricardo Montoya Olvera, Monterrey (MX); Jose Torres Quiroga, Garza Garcia (MX)

Correspondence Address: ABELMAN, FRAYNE & SCHWAB, 666 THIRD AVENUE, 10TH FLOOR, NEW YORK, NY, 10017, US

(73) Assignee: Industrial Organica, S.A. De C.V.

(21) Appl. No.: 11/540,113

(22) Filed: Sep. 29, 2006

(51) Int. Cl. A23K 1/18

(52) U.S. Cl. 426/2

(57) ABSTRACT

This invention is related to a method for improving the health condition of crustaceans grown in captivity, by the incorporation of a carotenoids concentrate obtained from a natural source to the feed of crustacean species, in order to improve the health condition of such aquatic animals. The improved health condition results in a noticeable gain in biomass and in a more attractive color.

### BACKGROUND OF THE INVENTION

1. Field of the Invention

This invention is related to methods for increasing the productivity of aquatic farms and more particularly to a method for improving the health of a population of crustaceans by dosing a carotenoid concentrate obtained from a natural source, to the feed of a population of crustaceans, that results in a noticeable weight increase, as well as in an increase of the survival rate.

2. Description of the Related Art

Carotenoids are widely distributed in nature. Total annual production in nature is estimated at over 100 million tons. This vast quantity of carotenoids is mainly stored in leaves, algae, bacteria, phytoplankton and zooplankton. However, despite their wide distribution, de novo synthesis has so far been limited to certain microorganisms, fungii, algae and higher plants. Animals, by contrast, depend totally on a dietary intake for their supply of carotenoids since they are only capable to modify the different carotenoids by processing them by digestion.

Carotenoids are terpenoid compounds that besides their typical pigmenting characteristics (yellow, orange or red pigments), function as precursors of molecules with biological activity intervening in different vital biological and physiological processes.

Over 800 different carotenoids have been recognized in nature. Carotenoids are classified in two major groups: carotenes, that are hydrocarbon molecules comprising atoms of carbon and hydrogen only. Representative examples of carotenes include β-carotene and lycopene. And xanthophylls, which are oxygenated derivatives of the carotenes. Representative examples of xanthophylls include lutein, zeaxanthin, astaxanthin, capsanthin and cantaxanthin.

In plants and animals, carotenoids are subject—after synthesis or ingestion—to diverse processes and structural modifications. The carotenoid distribution, as well as the metabolic pathways have been widely studied by previous investigators (Goodwin, 1984; Davies, 1985)

It has been recognized that many aquatic species require an optimum level of carotenoids in their diet in order to properly carry out vital biological, metabolic and reproductive functions (Olson 1993; Weiser and Korman 1993; Bendich 1994; Krinsky 1994).

The biological properties of carotenoids have been studied by different investigators (Torrisen et al.. 1989; Meyers and Latscha 1997) as source of Vitamin A, for its antioxidant properties, for its capacity of enhancing the immunological response and stabilization of the cellular membranes and for its capacity of functioning as oxygen reservoirs in some intracellular reactions, and generally in the oxygenation of cells and tissues (Torrisen 1989; Craik 1985; Grung et al. 1993; Watson and Earnest, 1993). Other research studies demonstrate the critical role played by Astaxanthin in marine tropic processes, regarding the conversion of β-Carotene into Astaxanthin through crustacean zooplankton feeding (Ringelberg 1980; Kleppel 1988).

Besides the many functions that provitamin A has in the metabolism of animals, carotenoids are also involved in a number of further physiological functions. Of particular interest in this regard is the beneficial effect of carotenoids on the endocrine system with respect to gonadal development and maturation of fertilization, of hatching, viability and growth, particularly in fish and crustaceans (Deufel, 1965, 1975; Hartmann et al., 1947,; Meyers, 1997) and on the reproductive processes in a variety of many animal classes and species, e.g. birds, cattle, horses and pigs (Bauernfeind, 1981). Although the specific role of carotenoids has not been established in detail during embryogenesis and vitelogenesis, some authors suggest that a good level of carotenoids help protect the embryos nutrient reserves from oxidation and sunlight damage (UV radiation) (Nelis et al., 1989).

The major pigment in most aquatic animals is Astaxanthin, but they differ fundamentally in their ability to synthesize this highly oxidized carotenoid from precursors. The crustaceans (omnivorous, lower order animals with a highly developed biosynthetic capability) are able to convert various algal carotenoids (e.g. lutein and zeaxanthin) and Beta-carotene into the major pigment, Astaxanthin. This carotenoid primarily occurs as protein complexes of free, mono- and diesters in the exoskeleton of most crustaceans (Meyers, 1986).

Astaxanthin is found as a major pigment in certain plankton forms, and numerous fishes (e.g. salmonids) and crustaceans. Besides its role as a pigment, Astaxanthin also has a number of metabolic functions, of which the most significant are probably its effects on reproduction and its provitamin A (Schiedt et al., 1985).

It has been established that Astaxanthin plays an important physiological function by acting as a chelating agent, or free radical quencher, of toxic metabolites produced at the intracellular level, and its potency is described as many times more efficient than Vitamin E (Miki, 1991). Several research studies report that the formation of carotenoproteins and carotenolipoproteins positively affects the cell membrane wall (Bendich, 1989; Prabahla et al., 1989; Menasveta, 1993).

The immunological system of crustaceans is very primitive, and basically it functions by means of hemocytes that function either as fagocytes, encapsulators, aglutinators or lysing invasive exogenous agents.

Crustaceans are omnivores and feed on phytoplankton and zooplankton. From the evolutionary point of view it is not surprising that these animals show a broader metabolic diversity than do fish and birds to modify their dietary carotenoids to suit their tissue-specific molecules (Schiedt, 1998)

In the natural environment phytoplankton and zooplankton are the source of Astaxanthin and Astaxanthin precursors for those organisms that follow in the feeding chain, such is the case of fishes and crustaceans. However, nature cannot provide the required amounts for aquaculture operations, and even less in intensive operations; it is therefore recommended the use of Astaxanthin in artificial diets as a supplement (Meyers and Latscha, 1997).

Today's intensive production methods which have developed to keep pace with requirements and quality standards result in a situation in which natural pigment sources can no longer provide an adequate carotenoid supply. Nowadays, the appropiate pigmentation of products demanded by consumers usually requires pigment additives.

Although carotenoid effects in crustaceans have been widely studied and documented, and there is ample evidence of their presence in many microalgae, fungii and bacteria in most marine waters, all previous efforts to supplement Astaxanthin in crustaceans have been devoted to incorporate in the feeds Astaxanthin from various sources, either obtained synthetically—Carophyll Pink (Roche, BASF)—or from natural sources (Haematoccocus pluvialis, Phaffia rhodozyma, shrimp meal, etc), but no known effort has been made to administer an optimum level of Astaxanthin precursors such as Zeaxanthin, and even more specifically a Zeaxanthin derivative.

The method of the present invention comprises the dosing of Zeaxanthin and Lutein concentrates, marigold oleoresin, marigold meal and Zeaxanthin and Lutein Short Chain Diesters like diacetates or dipropionates, derived from Tagetes erecta, to crustacean feeds that noticeably increase the survival rate and the growth rate of populations raised in captivity.

### SUMMARY OF THE INVENTION

It is therefore a main object of the present invention to provide a method for increasing the survival rates of crustaceans by dosing a Carotenoid extract derived from marigold with a content of Zeaxanthin or Zeaxanthin Short Chain Diesters that comprise from 10% to 90% of the total xanthophylls, to the feed of a population of crustaceans.

It is also a main object of the present invention to provide a method of the above disclosed nature in which the carotenoid concentrate is readily and efficiently converted into Astaxanthin by crustaceans.

It is an additional purpose of the present invention to provide a method of the above disclosed nature in which the carotenoid concentrate noticeably improves the health condition of a crustacean population in such a way that the growth rate is increased.

It is yet a main object of the present invention to provide a method of the above disclosed nature in which the carotenoid concentrate acts as a precursor of Vitamin A .

It is a further object of the present invention to provide a method of the above disclosed nature in which the carotenoid concentrate stimulates the immunological system of a crustacean population.

It is another main purpose of the present invention to provide a method of the above disclosed nature in which the carotenoid concentrate increases the survival rate of a crustacean population.

It is yet a main object of the present invention to provide a method of the above disclosed nature in which the carotenoid concentrate is readily converted into Astaxanthin by crustaceans and consequently improves the color of such population.

It is a further object of the present invention to provide a method of the above disclosed nature in which the Astaxanthin precursor is readily and efficiently converted by crustaceans into Astaxanthin by which there are obtained similar benefits than dosing more expensive sources of Astaxanthin to the crustacean feeds.

### BRIEF DESCRIPTION OF THE DRAWINGS

FIG. 1 is a graph showing Post-larvae survival of L. vanname under various feeding treatments including Hi-Zea.

FIG. 2 is a graph showing Astaxanthin concentration in micrograms per gram of body mass on different body parts of juveniles of L. vannamei.

FIG. 3 is a graph showing Astaxanthin concentration on different body parts of pre-adults of L. vannamei.

FIG. 4 is a graph showing the effect of carotenoid level on survival of shrimp in the presence of WSSV, IHHNV, and TSV infections.

### DETAILED DESCRIPTION OF THE INVENTION

The following examples illustrate the benefits obtained by dosing a carotenoid concentrate rich in Zeaxanthin or in Zeaxanthin Short Chain Diesters (Hi-Zea) to crustacean feeds. Such results were obtained in a series of experiments and evaluations carried on at aquaculture laboratories, experimental farms, and commercial operations.

Zeaxanthin concentrates and Zeaxanthin Short Chain Diesters concentrates were prepared according to the processes described in U.S. Pat. No. 5,523,494 and U.S. Pat. No. 5,959,138.

The Zeaxanthin concentrate, or the Zeaxanthin Short Chain Diester concentrate, were incorporated in all instances as a powder carried in a premix, or in beadlets form, or microencapsulated with gelatin or carbohydrates or starches, or as an oil dispersion that readily mixes with the other feed ingredients; and were fed as crumbles, or pellets of different sizes, according to the crustacean requirements. The Zeaxanthin or the Zeaxanthin Short Chain Diesters concentrates are very stable and losses due to heat treatment during the feed preparation were minimal.

The content of Zeaxanthin or Zeaxanthin or Zeaxanthin Short Chain Diesters in the feeds, were analyzed for total xanthophylls at each experiment, and every time that a new feed lot was prepared, following the AOAC Spectrophotometric Method of Analysis (A.O.A.C., 1984, 14^{th} Edition).

The concentration of total pigment in crustacean specimens extract was carried out by UV/VIS spectrophotometric methods measurement absorbance at 470 nm (A 1%=2100 in Hexane).

The analysis of free, mono and diester-Astaxanthin, β-carotene, lutein, and zeaxanthin were quantified by HPLC on a H₃ PO₄ modified silica gel column.

The Astaxanthin enantiometers deposited by the crustaceans specimens, or from its different organs, were quantified by HPLC after derivatization into the corresponding dicamphanates (Vecchi and Muller 1979).

The Zeaxanthin and the Zeaxanthin Short Chain Diesters have the following chiral composition: 3R, 3′R Zeaxanthin min. 20% and 3R,3′S Meso Zeaxanthin max 80%.

The Astaxanthin deposited by shrimp which received feed enriched with synthetic Astaxanthin (Carophyll Pink) have the following chiral composition in the deposited Astaxanthin:

| | |
|---|---|
| 3R,3′R Astaxanthin (Cis + Trans): | 15.1% |
| 3R,3′S Meso-Astaxanthin (Cis + Trans): | 37.6% |
| 3S,3′S Astaxanthin (Cis + Trans): | 47.3% |

The Astaxanthin deposited by shrimp which received feed enriched with the Zeaxanthin and the Zeaxanthin Short Chain Diesters have the following chiral composition in the deposited Astaxanthin

| | |
|---|---|
| 3R,3′R Astaxanthin (Cis + Trans): | 15.8% |
| 3R,3′S Meso-Astaxanthin (Cis + Trans): | 38.2% |
| 3S,3′S Astaxanthin (Cis + Trans): | 45.9% |

### EXAMPLES

The following examples illustrate the beneficial effect of the inclusion of a Zeaxanthin Concentrate or Zeaxanthin Diester Concentrate obtained from a natural source, and from now on called Hi-Zea, in the feed of shrimp at different stages of their life cycle. These examples are presented for illustrative purposes only and for a better understanding of the invention. However, they are not intended to limit the scope of the present invention.

### Example 1

1.—Dietary effect of the inclusion of Hi-Zea in the feed of a white shrimp Litopenaeus vannamei postlarvae (pl 7) cultivation.

An experiment was carried out with 6 treatments and three repetitions where white shrimp L. vannamei postlarvae (pl 7) were fed during 11 days with six different feed strategies. Treatments I to III included artemia nauplii. Besides artemia, Treatment TI was provided with commercial feed (40% protein). Treatment TII was supplemented with a commercial feed containing 138 ppm of xanthophylls, by including Hi-Zea in the formulation. Treatment TIII was provided with a microencapsulated commercial brand feed. Treatments IV to VI were provided with the same feed, but without artemia nauplii.

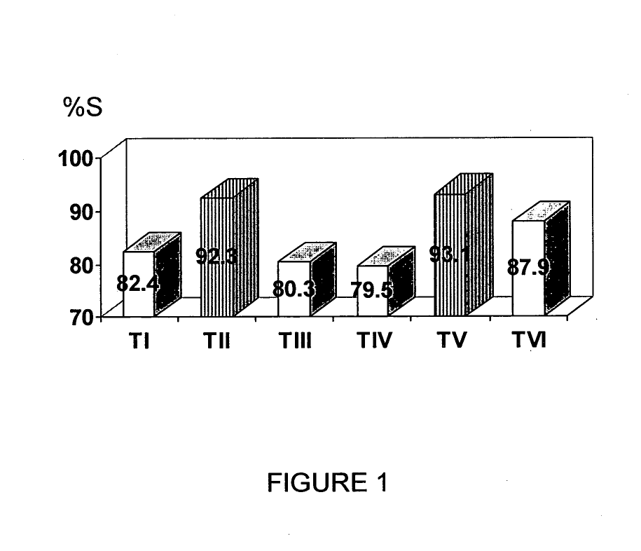

It can be observed in the graph of FIG. 1 that the Treatments including artemia nauplii (I to III), as well as those that did not include artemia (IV to VI), the experimental populations that were fed with Hi-Zea had a noticeable improvement in their survival (ANOVA 0.05%)

### Example 2

2.—Effect of dosing (Hi-Zea) in the feed of pre-juvenile (0.115 g) white shrimp Litopenaeus vannamei, grown under high density conditions.

An experiment was carried out comprising two treatments and three repetitions where pre-juvenile white shrimp L. vannamei were grown during 7 weeks, seeded at a high density (330 specimens/m²) in order to create a stress condition. In Treatment I a commercial feed was provided (40% protein). In Treatment II the commercial feed (40% protein) contained 138 ppm of xanthophylls from Hi-Zea.

As can be observed in Table I, the average weight as well as the average survival rate was significantly larger (ANOVA 0.05%) when Hi-Zea was used, as compared against those individuals that did not receive the carotenoid dose.

TABLE I
Final individual average weight and percentage of survival on Pre-
juveniles of L. vannamei.

| | Final average weight (g) | Survival % |
|---|---|---|
| Treatment I (Control) | 2.02 | 66.6 |
| Treatment II (Hi-Zea) | 2.63 | 73.1 |

### Example 3

3.—Dietary effect of dosing different concentrations of Hi-Zea in the feed of juvenile (2.5 g) white shrimp L. vannamei. Survival rate, growth, and pigmentation (astaxanthin deposition).

An experiment was carried out by triplicate, on an experimental stock of L. vannamei juveniles, being treated under different feeding strategies. On treatment I (Control) commercial feed with 35% protein was used, according to DICTUS formulation. On treatment II, Hi Zea was added to obtain a xanthophyll concentration of 58.7 ppm. On treatment III Hi Zea was added to obtain a xanthophyll concentration of 104.7 ppm.

After 30 days in the experimental ponds, the specimens were collected. Survival rate was determined to be significantly higher (ANOVA 0.05%) on experimental ponds treated with Hi Zea (Table II).

TABLE II
Juvenile survival of L. vannamei.

| | | | TIII (105 ppm Hi- |
|---|---|---|---|
| | TI | TII (60 ppm Hi-Zea) | Zea) |
| Survival % | 88 | 95 | 97 |

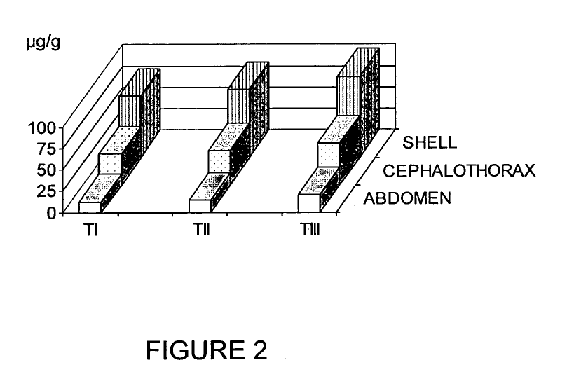

According to HPLC analysis, the Astaxanthin deposit on different body parts increased with relation to the Hi Zea level contained in the diet. Concentrations achieved on experimental Treatment III were significantly higher (ANOVA 0.05%) than those achieved on Treatments I and II (Graph of FIG. 2).

### Example 4

4.—Dietary effect of dosing of Hi Zea to feeds, at different dosages and over different feeding periods, on the survival rate and pigmentation of white pre-adult (17.0 g) shrimp L. vannamei.

An experiment was carried out by duplicate of three treatments, consisting of a two-way design, to analyze the combined effect of different xanthophyll levels on feeds and feeding periods on the survival rate and pigmentation of Pre-adult white shrimp.

Treatment I considered as a feeding control was based on a diet having a protein content of 35%, according to DICTUS formulation. Experimental Treatment II feed had a protein content of 35% and Hi Zea for increasing xanthophyll concentration to 58.7 ppm; and treatment III also had a protein content of 35% with the addition of Hi Zea for increasing xanthophyll concentration to 104.7 ppm

On Treatments I, II and III, experimental feeds were provided for 30 days. Afterwards the shrimp were collected.

Diets provided on treatments IV, V and VI are equivalent to those diets provided on treatments I, II and III accordingly, but were fed for a period of 60 days, after which the shrimp were collected.

Survival rate on shrimps treated with Hi Zea was significantly higher (ANOVA 0.05%) than control treatments, for both feeding periods of 30 and 60 days. Results are shown on Table III.

TABLE III
Pre-adult Survival of L. vannamei.

| | TI (Control) | TII (60 ppm Hi-Zea) | TIII (105 ppm Hi-Zea) |
|---|---|---|---|
| % S/Day 30 | 93.3 | 96.7 | 100 |
| % S/Day 60 | 80.0 | 93.3 | 100 |

According to HPLC analysis, the concentration of Astaxanthin on different body parts, after 30 days feeding period, were not significantly different (ANOVA 0.05%) between the three treatments. Although, after 60 days feeding period, concentrations of Astaxanthin on Cephalothorax and Abdomen on treatments II and III were significantly higher (ANOVA 0.05%) than those of treatment I. The Carapace Astaxanthin concentration on treatment III, was significantly higher (ANOVA 0.05%) than those of treatments I and II.

Astaxanthin concentrations recorded after the 60 days feeding period were higher than those obtained after the 30 days feeding period.

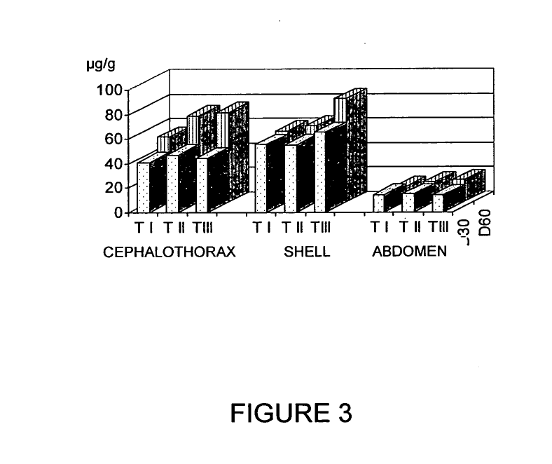

The results obtained, surprisingly show that there was a noticeable improvement in the survival rate by incorporating the Zeaxanthin Concentrate HiZea in the feed of shrimp as shown in the graph of FIG. 3.

### Example 5

5.—Dietary Supplementation with Hi-Zea to determine Survival Rate of Litopenaeus vannamei in a shrimp farm in the presence of WSSV

Although white spot syndrome virus (WSSV) has had a devastating economic effect on shrimp farming, variability in the severity of outbreaks that can be correlated to seasonal and environmental factors suggests an interaction between the disease and stress factors. In some cases, shrimp can survive exposure to WSSV, but the presence of stress factors can cause an acute outbreak of the disease. Treatments or management strategies that can improve the condition of shrimp can potentially increase resistance to disease, and maintain chronically infected shrimp without massive mortalities. Treatments that improve the condition of shrimp populations may increase resistance to disease and enable commercial operations to maintain chronically infected populations without massive mortalities.

The effect of dosing a Zeaxanthin Short Chain Diester Concentrate (Hi-Zea) to the feed of Litopenaeus vannamei on its growth and survival rates was evaluated in a grow out trial at Biocultivos Manabitas in Bahia de Caraquez, Manabi, Ecuador under conditions where the shrimp were exposed to WSSV, TSV, and IHHNV. High mortality during the trial was anticipated. To eliminate the effects of inter pond variability, the grow out trial was conducted in 100, 1 m² bottomless cages in a single 0.32 hectare pond. In each cage, a 5 cm diameter directional airlift provided aeration and vertical water movement within the cage, and horizontal movement between the inside and outside of the cage. Shrimp (5.5 g at stocking) were stocked in the cages at densities of either 20 or 40 shrimp m⁻². Shrimp (3.7 g at stocking) were stocked outside the cages at a density of 8.2 shrimp m⁻². Prior to stocking, shrimp had been reared from PL in lined ponds, and had survived exposure to WSSV. Water treatment during filling and the eight week growth trial were similar to that used for surrounding commercial culture ponds.

Shrimp were fed 0.20 g feed shrimp⁻¹ day⁻¹ inside the cages and 0.14 g feed shrimp⁻¹ day⁻¹ outside the cages. For shrimp inside the cages, feeds with three different content levels of Hi-Zea were compared to a feed without any content of Hi-Zea. For shrimp outside the cages, the feed without Hi-Zea was used. Proximate and carotenoid analyses of the feeds are shown in table 1. The Feed was provided in the form of pellets and were provided to the cages 5 times a day. Hi-Zea was mixed with fish oil and sprayed on the pellets after drying. Shrimp were fed with the experimental feeds for the first 23 days of the growth trial. After analyzing the feeds, it was found that carotenoid levels were below target levels in the feeds having 150 and 225 ppm, the content levels were corrected by spraying additional Hi-Zea on the pellets. The feed having the correct amount of 150 ppm was provided for the remaining of the trial days (days 24-56). The feed having the correct amount of 225 ppm feed, which was used for days 24-35, was still below the target level. The carotenoid level was corrected again and used for the remainder of the trial days (days 36-56).

TABLE 1
Proximate Analysis and Carotenoid Content of Feeds

Feed (ppm carotenoid)

| | | | |
|---|---|---|---|
| 0 | 75 | 150 | 225 |

Proximate analysis (%)*

| | | | | |
|---|---|---|---|---|
| Protein | 30 | 34 | 36 | 36 |
| Lipid | 5 | 9 | 9 | 8 |
| Fiber | 3 | 2 | 2 | 2 |
| Ash | 9 | 8 | 8 | 8 |

Carotenoid (ppm)**

| | | | | |
|---|---|---|---|---|
| June 1–23 | 13 | 67 | 108 | 96 |
| June 24–July 5 | 18 | 68 | 142 | 186 |
| July 6–27 | 18 | 68 | 142 | 232 |

*Laboratorio de Alimentos, Medicamentos y Toxicologia, Universidad Autonoma de Nuevo Leon, San Nicolas de Los Garza, N. L., Mexico
**Research and Development Department, Industrial Organica, S. A., Monterrey, N. L., Mexico

### Growth and Survival

Growth and survival at harvest was analyzed by a two-way variance analysis. Interactions between stocking density and diet were not significant for either growth or survival (P=0.5147 and 0.4515, respectively).

Survival (FIG. 1) was greater at the stocking density of 20 shrimp/m² than at 40 shrimp/m² (P=0.0001). At 20 shrimp/m², survival ranged from 21 to 70%, and at 40 shrimp/m², ranged from 7 to 39%. At both stocking densities, survival was greater for the fed shrimps than for the unfed shrimp (P=0.0001). At both stocking densities, survival was greater with the feed containing Hi-Zea than with the feed without Hi-Zea (P=0.0005). Differences in survival between feeds containing Hi-Zea were not significant (P=0.2458).

### Pathological Analysis

At harvest, there was sampled hemolymph from the shrimp fed containing from 0 to 150 ppm of carotenoid at the stocking density of 20 shrimp/m² for pathological analysis. PCR tests for IHHNV and WSSV, and immune-blot dot tests for IHHNV, WSSV, and TSV indicated high levels of infection by all three viruses in both groups of shrimp.

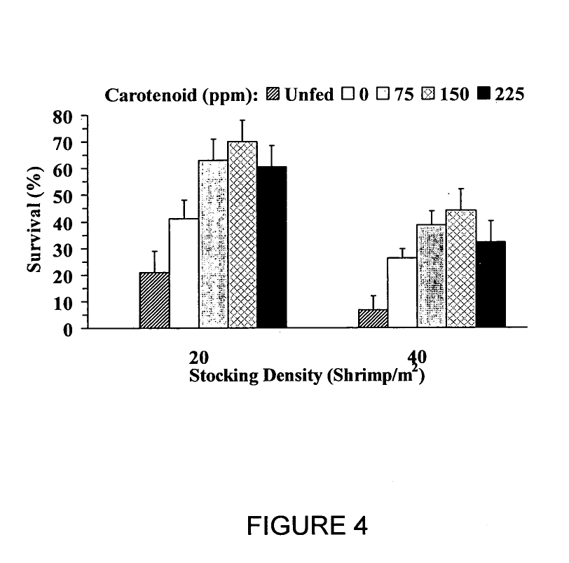

The growth trial demonstrated that the dosing of Zeaxanthin Short Chain Diester Concentrate (Hi-Zea) surprisingly increased the survival of shrimp in the presence of WSSV, IHHNV, and TSV infections as shown in the graph of FIG. 4.

### Example 6

6.—Effects of different sources and doses of carotenoids in the balanced feed, growout, survival, and deposition of pigments in white shrimp L. vannamei.

The following is a review of the results obtained regarding the dosing of Hi Zea in the feed, as compared to feed that contained synthetic Astaxanthin (Carophyll Pink). The average survival and final weight results of the experimental work with shrimp L. vannamei results, obtained after a 60 day treatment, are shown in the following table:

| | FINAL WEIGHT | | ASTAX. IN | ASTAX. IN | ASTAX. IN |
|---|---|---|---|---|---|
| TREATMENT | grs | SURVIVAL % | HEAD* | MUSCLE* | SHELL* |
| Control | 7.55 | 61.11 | 27.4 | 9.3 | 50.4 |
| ROCHE | 7.77 | 63.33 | 29.3 | 11.6 | 80.8 |
| Astaxanthin | | | | | |
| 75 ppm | | | | | |
| Hi Zea | 7.94 | 65.55 | 40.3 | 16.3 | 71.6 |
| 75 ppm | | | | | |
| Hi Zea | 7.82 | 81.11 | 37.7 | 14.3 | 72.3 |
| 100 ppm | | | | | |
| Hi Zea | 7.81 | 78.89 | 45.7 | 11.9 | 76.0 |
| 200 ppm | | | | | |

*micrograms of astaxanthin per gram of tissue in the head (hepatopancreas), muscle and shell (carapace)

Differences observed on the final weights were not statistically significant. On the other hand, survival rates were statistically significant, and their value increased in direct ratio to the increment of Hi Zea dosage.

Astaxanthin deposition using 75 ppm of Hi Zea was similar to that obtained with 75 ppm of synthetic Astaxanthin, differences observed were not statistically significant in any of the three body parts analyzed by HPLC.

This indicates that Hi Zea is efficiently incorporated on the different tissues and body parts, and the energetic cost of this metabolic change is definitely despicable, as it is not reflected statistically on the growth performance.

### Example 7

7.—Comparison of the different Astaxanthin enantiomers deposited by P. monodon that were given the following three different diets: commercial feed as control; commercial feed containing 120 ppm of Zeaxanthin Short Chain Diester Concentrate (Hi-Zea); and commercial feed that contained 60 ppm of synthetic Astaxanthin (Carophyll Pink).

An evaluation was carried on a commercial operation to determine the effect of feeding P. monodon shrimp with the same commercial feed that contained:
a) no extra carotenoid,
b) 120 ppm of Hi-Zea, and
c) 60 ppm of synthetic Astaxanthin (Carophyll Pink)

The specimens were seeded at 30/m², pl 7, in aerated and lined ponds. The ponds sizes were 0.25 Ha each.

Five ponds selected at random were fed with the feed containing no added carotenoid.

Five additional ponds, randomly selected were given feed containing 120 ppm of Hi-Zea, and

Another five ponds located at random, were given feed containing 60 ppm of synthetic Astaxanthin (Carophyll Pink)

All ponds were seeded the same date with pl of the same origin. Water quality was uniform, as well as the fertilization and management of the ponds. Natural production of phytoplankton and zooplankton was abundant in all the ponds.

At three grams weight, the ponds were sampled, the specimens were lyophillized and the dehydrated samples were ground and analyzed.

The concentration of total pigment in the crustacean specimens extract was carried out by UV/Vis spectrophotometric methods measurement absorbance at 470 nm (A 1%=2100 in hexane).

The results obtained were as follows:

| | |
|---|---|
| Ponds with Hi-Zea treatment: | 179.4 ppm |
| Ponds with Carophyll Pink: | 153.6 ppm |
| Control ponds: | 153.1 ppm |

The analysis of Astaxanthin R/S enantiomers deposited by the crustacean specimens, were quantified by HPLC after derivatization into the corresponding dicamphanates (Vecchi and Muller 1979), in order to differentiate the Astaxanthin enantiomers. The results were as follows:

| Control Ponds: | |
|---|---|
| 3R,3′R Astaxanthin (Cis + Trans): | 14.2% |
| 3R,3′S Meso-Astaxanthin (Cis + Trans): | 37.2% |
| 3S,3′S Astaxanthin (Cis + Trans): | 48.5% |
| Ponds with Hi-Zea treatment: | |
| 3R,3′R Astaxanthin (Cis + Trans) | 15.8% |
| 3R,3′S Meso-Astaxanthin (Cis + Trans): | 38.2% |
| 3S,3′S Astaxanthin (Cis + Trans): | 45.9% |
| Ponds with Carophyll Pink treatment: | |
| 3R,3′R Astaxanthin (Cis + Trans): | 15.1% |
| 3R,3′S Meso-Astaxanthin (Cis + Trans): | 37.6% |
| 3S,3′S Astaxanthin (Cis + Trans): | 47.3% |

As it can be observed, there is no statistical difference in the proportion of the different Astaxanthin enantiomers deposited by P. monodon in any of the three different treatments.

The above suggests that P. monodon shrimp have the capability to convert and deposit the Zeaxanthin precursor contained in the Hi-Zea; as well as the precursors found in the phytoplankton and zooplankton of the control ponds; as well as the Astaxanthin contained in the Carophyll Pink. In all three instances, the crustacean showed the capability to provide identical depositions, starting from different sources and following a unique metabolic pathway. To our knowledge, there is no report of such discovery.

What is claimed is:

1. A method for improving the health condition of a crustacean population, comprising the incorporation of a Carotenoids Concentrate, having a content of Zeaxanthin or Zeaxanthin Short Chain Diesters comprising from 10 to 90% of the total xanthophylls, in crustaceans feeds.

2. A method as claimed in claim 1, wherein the Carotenoids Concentrate, having a content of Zeaxanthin or Zeaxanthin Short Chain Diesters, is incorporated in the feed of a crustacean population living in a tank containing water when the water has a low content of micro algae, zooplankton, carotenoids or Astaxanthin precursors.

3. A method as claimed in claim 1, wherein the Carotenoids Concentrate with a content of Zeaxanthin or Zeaxanthin Short Chain Diesters, are dosed in crustaceans feeds in an amount of from 10 ppm to 500 ppm.

4. A method as claimed in claim 1 wherein the Carotenoids Concentrate having a content of Zeaxanthin or Zeaxanthin Short Chain Diesters, act as Astaxanthin precursors that are readily and efficiently converted into Astaxanthin by crustaceans.

5. A method as claimed in claim 1, wherein the Carotenoids Concentrate with a content of Zeaxanthin or Zeaxanthin Short Chain Diesters, when provided to a given crustacean population raised in captivity results in a suitable Astaxanthin level that improves the health condition of such population.

6. A method as claimed in claim 1 wherein the Carotenoids Concentrate having a content of Zeaxanthin or Zeaxanthin Short Chain Diesters acts as an Astaxanthin precursor that is readily and efficiently converted into Astaxanthin which improves the color of the population of crustaceans.

7. A method as claimed in claim 1, wherein the Carotenoids Concentrate with a content of Zeaxanthin or Zeaxanthin Short Chain Diesters, noticeably improves the health condition of a crustacean population in such a way that the growth rate is increased.

8. A method as claimed in claim 1, wherein the Carotenoids Concentrate with a content of Zeaxanthin or Zeaxanthin Short Chain Diesters, noticeably improves the survival rate.

9. A method as claimed in claim 1 wherein the Carotenoids Concentrate having a content of Zeaxanthin or Zeaxanthin Short Chain Diesters acts as precursor of Vitamin A.

10. A method as claimed in claim 1, wherein the Carotenoids Concentrate with a content of Zeaxanthin or Zeaxanthin Short Chain Diesters, stimulate the immunological system of a crustacean population.

11. A method as claimed in claim 1, wherein the Concentrate with a content of Zeaxanthin or Zeaxanthin Short Chain Diesters, are readily converted into Astaxanthin by crustaceans and consequently the color of such population is noticeably improved.

12. A method as claimed in claim 1, wherein the Carotenoids Concentrate with a content of Zeaxanthin or Zeaxanthin Short Chain Diesters, when such carotenoid concentrate is used during all the growout cycle.

13. A method as claimed in claim 1, wherein the Carotenoids Concentrate with a content of Zexanthin or Zeaxanthin Short Chain Diesters, when such carotenoid concentrate is used partially during the grow out cycle.

14. A method as claimed in claim 1 wherein the Carotenoids Concentrate having a content of Zeaxanthin or Zeaxanthin Short Chain Diesters improves the viability and survival of post larvae and the fertility of broodstock in crustacean hatcheries.

15. A method as claimed in claim 1 wherein the Carotenoids Concentrate with a content of Zeaxanthin or Zeaxanthin Short Chain Diesters, is used to improve the color of decorative, commercial, and carpid fish species.

16. A method as claimed in claim 1, wherein the Carotenoids Concentrate with a content of Zeaxanthin or Zeaxanthin Short Chain Diesters, is incorporated into the feed by means of a powder carried in a premix.

17. A method as claimed in claim 1, wherein the Carotenoids Concentrate with a content of Zeaxanthin or Zeaxanthin Short Chain Diesters, is incorporated into the feed as beadlets.

18. A method as claimed in claim 1, wherein the Carotenoids Concentrate with a content of Zeaxanthin or Zeaxanthin Short Chain Diesters, is incorporated into the feed as an oil dispersion.

19. A method as claimed in claim 1, wherein the Carotenoids Concentrate with a content of Zeaxanthin or Zeaxanthin Short Chain Diesters, is incorporated in feed crumbles.

20. A method as claimed in claim 1, wherein the Carotenoids Concentrate with a content of Zeaxanthin or Zeaxanthin Short Chain Diesters, is incorporated in feed pellets.

21. A method for improving the health condition of a crustacean population, comprising the incorporation of a Carotenoids Concentrate obtained from marigold petals meal with a total xanthophylls content of 6 gr/kg to 25 gr/kg.

22. A method for improving the health condition of a crustacean population, comprising the incorporation of a Carotenoids Concentrate obtained from marigold oleoresin with a total xanthophylls content of 75 gr/kg to 150 gr/kg.

23. A method for improving the health condition of a crustacean population, comprising the incorporation of a Carotenoids Concentrate obtained from capsicum species meal with a total xanthophylls concentration of 3 gr/kg to 16 gr/kg.

24. A method for improving the health condition of a crustacean population, comprising the incorporation of a Carotenoids Concentrate obtained from capsicum species oleoresin with a total xanthophylls concentration of 15 gr/kg to 75 gr/kg.
